(19) United States
(12) Patent Application Publication
(10) Pub. No.: US 2026/0128843 A1
(43) Pub. Date: May 7, 2026

(54) LOW OVERHEAD SUBBAND-BASED UPLINK PRECODING

(71) Applicant: InterDigital Patent Holdings, Inc., Wilmington, DE (US)

(72) Inventors: Afshin Haghighat, Ile-Bizard (CA); Loic Canonne-Velasquez, Dorval (CA); Mohammad Irfan, Chateauguay (CA); Jonghyun Park, Syosset, NY (US); Roozbeh Mohammadian, Outremont (CA)

(73) Assignee: InterDigital Patent Holdings, Inc., Wilmington, DE (US)

(21) Appl. No.: 18/936,355

(22) Filed: Nov. 4, 2024

(51) Int. Cl. H04L 5/00; H04B 7/0413; H04W 72/21; H04W 72/232

(52) U.S. Cl. CPC H04L 5/0094; H04B 7/0413; H04L 5/0048; H04W 72/21; H04W 72/232

(57) ABSTRACT

A wireless transmit/receive unit (WTRU) may receive a (RS) configuration. The RS may comprise an indication of a plurality of −RSs mapped in an irregular pattern in a channel over a plurality of subbands. The RS configuration may comprise information associated with the irregular pattern. The WTRU may estimate a channel information over the plurality of subbands that comprise no RSs. The estimation may be based on the one or more RSs mapped in the irregular pattern and the information associated with the irregular pattern. The WTRU may receive downlink control information (DCI). The DCI may comprise an indication of an uplink transmission and an indication of the subbands within the plurality of subbands available for the uplink transmission. The WTRU may determine, per each subband, uplink precoders for the scheduled uplink transmission based on the estimation. The WTRU may send the uplink transmission using the uplink precoders.

### BACKGROUND

In a multi-input multi-output (MIMO) system, there are two main modes of precoding: codebook-based precoding and non-codebook-based precoding. In a codebook-based uplink precoding, a wireless transmit/receive unit (WTRU) may receive an explicit indication as to which precoders may be used for a scheduled transmission. The indication may take the form of an index that points to a specific precoder from a codebook known to both WTRU and/or gNB, such as a transmitted precoding matrix indicator (TPMI) as used in new radio (NR). In a non-codebook-based uplink precoding, the scheduled uplink transmission may use and explicit indication of a precoder. Instead, the precoding determination may be based on channel reciprocity. In channel reciprocity, a WTRU may determines a best precoder for the uplink precoding based on the observed channel on a received downlink reference signal (RS), such as a channel state information (CSI) reference signal (RS).

As wireless channels exhibit frequency selective behavior, it may be beneficial for a precoding-based MIMO system to support precoding on a subband-basis to better match channel frequency response. Due to concerns related to the required feedback overhead for precoder indication (e.g., in the case of codebook-based precoding) and/or downlink reference density (e.g., in the case of non-codebook-based precoding), uplink transmission may be based on wideband precoding. Therefore, design of an efficient procedure for subband-based precoding for uplink transmission remains an important issue.

### SUMMARY

A wireless transmit/receive unit (WTRU) may receive a reference signal (RS) (e.g., a channel state information (CSI) reference signal (RS)) configuration. The RS may comprise an indication of a plurality of RSs mapped in an irregular pattern in a channel over a plurality of subbands. The RS configuration may comprise information associated with the irregular pattern. The WTRU may estimate a channel information over the plurality of subbands that comprise no RSs. The estimation may be based on the one or more RSs mapped in the irregular pattern and the information associated with the irregular pattern. The WTRU may receive downlink control information (DCI). The DCI may comprise an indication of an uplink transmission and an indication of the subbands within the plurality of subbands available for the uplink transmission. The WTRU may determine (e.g., per each subband within the plurality of subbands) uplink precoders for the scheduled uplink transmission based on the estimation. The WTRU may send the uplink transmission using the uplink precoders.

The irregular pattern may comprise a plurality of RSs that are not uniformly distributed throughout the channel. The irregular pattern may comprise a plurality of RSs that are not evenly spaced throughout the channel.

The RS configuration may comprise a configured bandwidth of the RSs, an indication of the mapping of the RSs in a frequency domain, or a rotation value of the irregular pattern. The WTRU may determine, by dividing the configured bandwidth of the RSs with a size of the subband on the channel for estimation, the number of subbands within the plurality of subbands on the channel for estimation. The indication of the mapping of the RSs in a frequency domain may comprise a bitmap, wherein the bitmap indicates the location of the RSs from a set of candidate locations. The configured bandwidth of the RSs may be wider than or equal to a bandwidth associated with the uplink transmission.

The information associated with the irregular pattern may be a sparsity order. The determination of the uplink precoders is based on a plurality of frequency locations within the plurality of subbands that comprise no RSs. The WTRU may receive configuration information. The configuration information may comprise one or more of a precoding resolution or an indication of a maximum number of multiple input multiple output (MIMO) layers.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of reference signal (RS) optimization based on the determined channel sparsity.

FIG. 3 depicts a process for sparse channel state information (CSI) reference signal (RS)-based TPMI determination by a wireless transmit/receive unit (WTRU).

FIG. 4 depicts a process for sparse CSI-RS-based TPMI determination by a network (e.g., gNB).

FIG. 5 depicts a process for sparse signaling reference signal (SRS)-based transmitted precoding matrix indicator (TPMI) determination by a WTRU.

FIG. 6 depicts a process for sparse SRS-based TPMI determination by a network (e.g., gNB).

### DETAILED DESCRIPTION

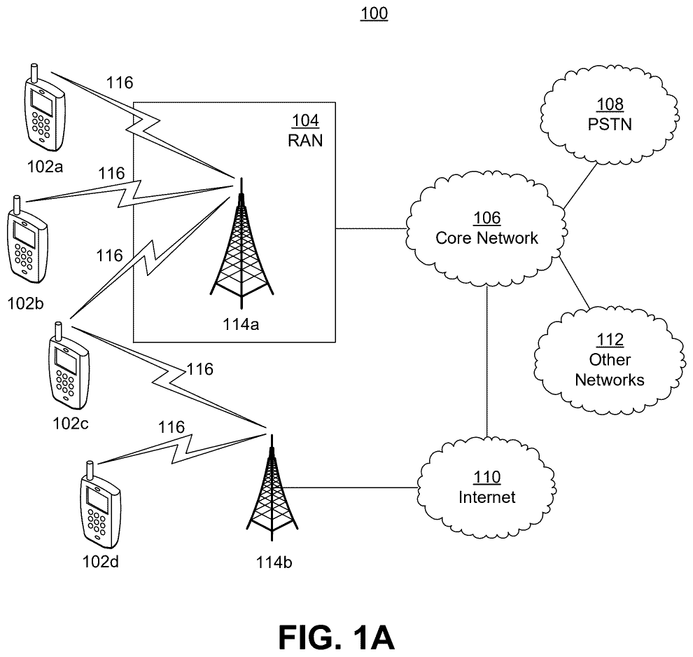

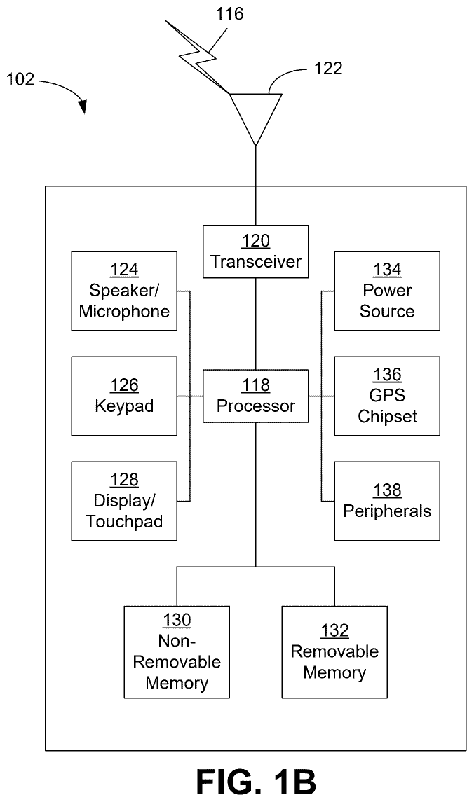

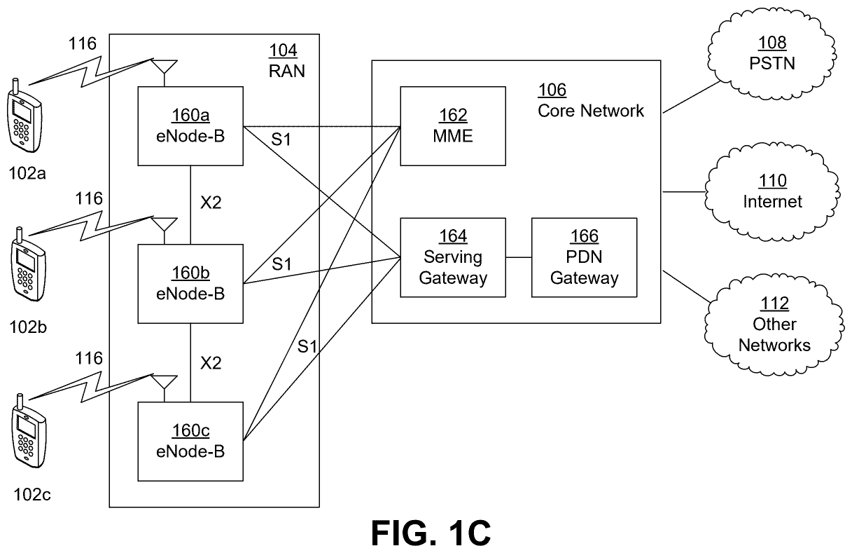

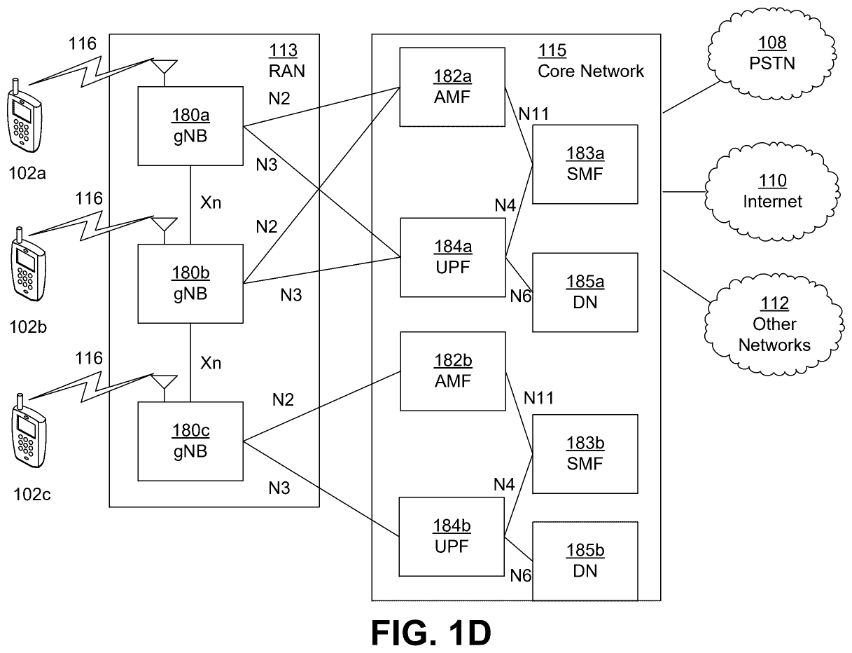

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Compressive sensing (CS) may be a method for efficient processing of a signal according to its inherent statistical behavior. For example, by relying on a set of basis vectors, compressive sensing may allow sampling of a signal at a lower sampling frequency than the Nyquist rate. As such, the regeneration of the series may be realized through the information available by a few samples (e.g., the coefficients).

The general concept of CS hinges on the notion of the sparsity of the target signal. A small set of samples (e.g., the coefficients) may be used for reproduction of the original signal by scaling and/or summation of the basis vectors. The ratio of the number of dominant coefficients to the number of coefficients with a negligible power may characterize the sparsity-ness of a series. In its simplest form, the sparsity order of a series may be determined by counting the number of non-zero coefficients.

Channel estimation may be a key step in wireless communication systems. To achieve reliable estimation of wireless communication channels, commonly high-density reference signals (RSs) may be used. A high-density RS may be referred to as a RS pattern that has a higher rate of transmission than the coherency of channel in frequency and/or time domain. RSs have been designed to support various operations of the system, e.g., channel sounding for estimating the channel state information (CSI). While the existing systems have some degrees of flexibility in selection of the RS pattern, the patterns do not often match channel behavior closely. In other words, to facilitate the applicability of RSs to all types of wireless channels, current RSs may be designed with high density in the frequency domain. Although generalization of the existing RSs to estimation of all channels is desirable, the RSs' high density may lead to large overhead on communication systems. This added burden may adversely affect the spectral efficiency (SE) of the communications system. One solution for preserving the quality of channel sounding with lower RSs overhead is utilizing the sparse and/or compressible structure of wireless channels. In examples, wireless channels may be represented by only a small number of parameters. In such cases, the channels are called sparse and/or compressible. Mathematically, h_(L×1) may be called a s-sparse vector and/or signal if it has at most s non-zero elements where s<<L. Accordingly, s is referred to as the sparsity order and/or level of h_(L×1). Following the sparsity definition, a vector may be called compressible if a sparse vector can approximate it.

Sparsity and/or compressibility of wireless channels may be seen in the time domain (delay domain), in the spatial domain, or both. For instance, in the environments where a few significant scatterers shape the propagation channel only a limited number of taps of the channel impulse response (CIR) may contain most of the channel energy. Under such conditions, the wireless channel may be considered sparse and/or compressible in the time domain.

(CS) has revealed that a sparse signal may be recovered and/or reconstructed from its samples with much lower sampling frequency than the conventional Nyquist rate. The standard problem of interest in the CS theory is finding the desired vector h∈C\hat{ }(L×1) from the following noisy under-determined linear system of equations as depicted in Equation (1):

$$y = ϕ h + n \qquad ( 1 )$$

under the assumption that h is a s-sparse vector (s<<L), and the number of linear measurements of h, the number of elements in y∈C\hat{ }(m×1), satisfies s<m<<L. In Equation (1), the term n∈C\hat{ }(m×1) represents the measurement noise. In the context of CS theory, y and φ are, respectively, referred to as the measurement vector and the measurement matrix. CS theory provides that under some conditions on the measurement matrix, φ, there exists efficient methods such as orthogonal matching pursuit (OMP) that may efficiently solve Equation (1) for h if m≈O(s log(L/s).

According to the CS theory, results achieved for sparse signals may readily be extended to the compressible signals as well. The concept of compressibility is much more important than sparsity, as most natural signals may be compressible rather than being exactly sparse. Since wireless communication channels may be seen as compressible signals, the results and/or tools introduced by the CS theory apply to estimation of wireless channels. This may result in the reduction of RSs overhead and/or improvement of the system SE.

In wireless orthogonal frequency division multiplexing (OFDM) systems, the channel estimation problem may be considered as finding h∈C\hat{ }(L×1), the CIR with effective length L, as depicted in Equation (2):

$$y = XFh + n \qquad ( 2 )$$

where y∈C\hat{ }(m×1) comprises the received signals over the subcarriers carrying the RSs, X∈C\hat{ }(m×m) is a diagonal matrix with RSs over its main diagonal, F\hat{ }(m×L) is the partial discrete Fourier transform (DFT) matrix, and n∈C\hat{ }(m×1) represents the additive noise. Comparing Equation (2) with Equation (1) reveals that CIR estimation may be seen as a standard CS problem with φ≙XF as the measurement matrix. Therefore, a RS designed based on the CS theory may adapt the RS and/or pilot pattern to the sparse and/or compressible wireless channel, and avoid over-, and/or under-transmission of RSs and/or pilots.

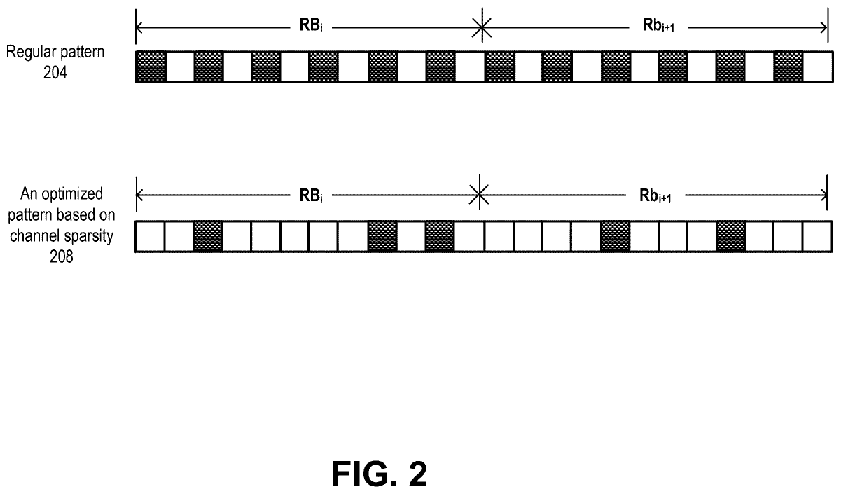

The application of CS in wireless communications may extend beyond sparse channel estimation. A significant advantage of CS in communication systems is its potential to reduce CSI feedback overhead. CS-based reduction of CSI feedback overhead may be achieved through various approaches. One such approach may leverage the principle that redundancy and/or correlation among signals may lower the effective amount of conveyed information compared to the sum of each signal's individual information. FIG. 2 depicts at 204 a regular RS pattern in comparison to a case at 208 where the density of a RS is optimized according to the determined channel sparsity.

In massive MIMO systems, for instance, strong spatial correlations may be typically observed due to closely packed antenna arrays. By applying specific transformations, channel vectors may be sparsified in the spatial-frequency domain. This sparse representation may enable CS-based compression of the estimated CSI, effectively reducing feedback overhead. The gNB may then decompress the received CSI using CS-based reconstruction methods.

When the gNB is situated at high altitudes with few surrounding scatterers, the angle spread around it is limited. Under such conditions, applying suitable transformations to the estimated wireless channels yields a sparse representation in the virtual angular domain. This representation is similar to sampling channel vectors at evenly spaced angular points at the gNB. With a restricted angle spread, the angular representation may reveal hidden sparsity within wireless channels. CS may then utilize this sparsity to reduce CSI feedback overhead.

Furthermore, the spatial characteristics of wireless channels across the system bandwidth may remain relatively unchanged over closely spaced subcarriers in OFDM systems. This property indicates that the virtual angular domain representation of wireless channels may share common sparse patterns across different subcarriers, thereby representing frequency-domain correlation in OFDM systems. During the coherence time interval, fundamental characteristics of wireless channels may be assumed to remain stable. This characteristic may result in high correlation of channel vectors in the time domain. CS-based tools may exploit these frequency and/or time-domain correlations for further reduction of CSI feedback overhead in wireless communication systems.

In these cases, wireless channels may not naturally appear sparse. However, with specific transformations, the wireless channels may be made sparse. Being made sparse may allow CS tools to compress and/or feedback the CSI efficiently. This shows that CS may be useful even in wireless systems without obvious sparse structures, highlighting its broad usefulness in wireless communications.

In new radio (NR), the uplink precoding performance may be limited due to various reasons, including the restriction to use wideband precoding. Despite potential performance enhancement resulted from subband precoding that may better match channel variation over frequency domain, subband precoding has not been adopted due to concerns of high overhead associated with the required CSI-RS for channel sounding and/or transmitted precoding matrix indicator (TPMI) indication. For example, for a WTRU configured in non-codebook operation, due to high variability of location of uplink resources, CSI configuration may need frequently reconfiguration. Moreover, the CSI configuration may have very large bandwidth needs for configuration. Either case hurts efficient use of system resources. In the case of codebook operation, a similar issue may arise for use of uplink sounding resources following by issues related to reporting variable load size for TPMI indication.

The main objective of the disclosure is to develop procedures for high resolution uplink precoding based on sparsity-based quantization to reduce the overhead associated to CSI-RS transmission and signaling. While the solution is described for uplink precoding, the presented solution may be equally applicable for a downlink precoding scenario as well.

In high resolution subband precoding, the WTRU may receive a configuration to perform subband precoding for uplink transmission. For example, the configuration may also include at least one of precoding resolution that is the number of PRBs sharing a same precoding (NPRG), and/or a maximum number of MIMO layer (Lmax).

The WTRU may receive a CSI-RS configuration (e.g., CSI-RS-S). In a CSI-RS configuration (e.g., CSI-RS-S), the RS may be mapped based on the sparsity of the channel. The configuration may include at least one of: the configured bandwidth of CSI-RS-S (B_{CS}, e.g., in physical resource blocks (PRBs); the information related to the mapping of CSI-RS-S in frequency domain (e.g., in resource elements (REs)), by, e.g., a bitmap; the sparsity order information N_{SO}, from which the WTRU can determine the mapping of CSI-RS-S from a set of configured mappings; and/or the rotation and/or shift parameter for the configured CSI-RS-S mapping.

According to the configured CSI-RS-S, the WTRU may receive the CSI-RS-S transmitted on P locations in the frequency domain per layer over the configured bandwidth of CSI-RS-S (X).

The WTRU determines the number of subband N, by division of the configured bandwidth of CSI-RS-S (B_{CS}) by the subband size (N_{PRG}). For example, if B_{CS} and/or N_{PRG} results in a non-integer value, a rounding function, (e.g., a ceiling functions, floor function, etc.) may be used.

Based on the received CSI-RS-S resource, and/or the sparsity order N_{SO}, the WTRU may estimate the channel over N (≥P) subbands. According to the Lmax, the WTRU may also determine precoders for each of N subbands.

The WTRU may receive a scheduling downlink control information (DCI) for an uplink transmission over Y (Y≤B_{CS}) PRBs according to a configured/indicated rank (RI). For example, a WTRU may receive an indication for NPRG in the DCI if not configured or to override a configured value.

For the scheduled UL transmission, the WTRU may divide the scheduled bandwidth Y into M subbands, where M is determined by division of the scheduled bandwidth (Y) by the subband size (NPRG). For example, if Y/NPRG results in a non-integer value, a rounding function (e.g., a ceiling functions, floor function, etc.) may be used.

The WTRU may determine M subband precoders for uplink physical uplink shared channel (PUSCH) transmission. In an example, the WTRU may determines M (≥P) precoders based on the estimated channels over N subband. In another example, the WTRU may determine P precoders based on the estimated channel on P locations, then determines M (≥P) precoders from P determined precoders. The WTRU may transmit the scheduled PUSCH, using the determined precoder per subband.

The WTRU may receive a CSI-RS configuration (e.g., CSI-RS-S). In a CSI-RS configuration (e.g., CSI-RS-S), the RS may be mapped based on the sparsity of the channel. The configuration may include at least one of: the configured bandwidth of CSI-RS-S (B_{CS}, e.g., in physical resource blocks (PRBs)); the information related to the mapping of CSI-RS-S in frequency domain (e.g., in resource elements (REs)), by, e.g., a bitmap; the sparsity order information N_{SO}, from which the WTRU can determine the mapping of CSI-RS-S from a set of configured mappings; and/or the rotation and/or shift parameter for the configured CSI-RS-S mapping.

According to the configured CSI-RS-S, the WTRU may receive the CSI-RS-S transmitted on P locations in the frequency domain per layer over the configured bandwidth of CSI-RS-S (X).

The WTRU determines the number of subband N, by division of the configured bandwidth of CSI-RS-S (B_{CS}) by the subband size (N_{PRG}). For example, if B_{CS} and/or N_{PRG} results in a non-integer value, a rounding function, (e.g., a ceiling functions, floor function, etc.) may be used.

Based on the received CSI-RS-S resource, and/or the sparsity order N_{SO}, the WTRU may estimate the channel over N (≥P) subbands. According to the Lmax, the WTRU may also determine precoders for each of N subbands.

The WTRU may receive a scheduling downlink control information (DCI) for an uplink transmission over Y (Y≤B_{CS}) PRBs according to a configured/indicated rank (RI). For example, a WTRU may receive an indication for N_{PRG} in the DCI if not configured or to override a configured value.

For the scheduled UL transmission, the WTRU may divide the scheduled bandwidth Y into M subbands, where M is determined by division of the scheduled bandwidth (Y) by the subband size (NPRG). For example, if Y/NPRG results in a non-integer value, a rounding function (e.g., a ceiling functions, floor function, etc.) may be used.

The WTRU may determine M subband precoders for UL PUSCH transmission. In an example, the WTRU may determines M (≥P) precoders based on the estimated channels over N subband. In another example, the WTRU may determine P precoders based on the estimated channel on P locations, then determines M (≥P) precoders from P determined precoders. The WTRU may transmit the scheduled PUSCH, using the determined precoder per subband.

A WTRU may determine a precoder for an uplink transmission using a configured downlink refence signal, (e.g., a configured CSI-RS). Further, the WTRU may receive several additional pieces of information to perform subband precoding for uplink transmission.

The WTRU may receive precoding resolution to perform subband precoding for uplink transmission. The WTRU may receive a dynamic and/or a semi-static indication and/or configuration to determine precoding resolution, where a precoding resolution may define the span of the frequency resource that shares a same precoding function. The span of frequency may be translated into a unit of frequency resource (e.g., the number of PRBs sharing a same precoding (e.g., NP_{RG}). In an example, the precoding resolution may be defined by an indicated and/or configured N_{PRG}. Additionally or alternatively, an N_{PRG} may be determined by M, where M is the number of subbands. In another example, the relationship between N_{PRG} and M may be expressed by N_{PRG}=Y/M, where Y is the scheduled bandwidth expressed in the same frequency resource unit as N_{PRG}.

A WTRU may receive a maximum number of MIMO layer (Lmax) to perform subband precoding for uplink transmission. The WTRU may receive a dynamic and/or a semi-static indication and/or configuration for the maximum number of MIMO layers the WTRU needs when computing the uplink precoder.

A WTRU may receive a CSI-RS configuration (e.g., CSI-RS-S) for determination of the uplink precoder, where the RS may be mapped based on a specific pattern. For example, the mapping of the CSI-RS may be based on an irregular pattern in time and/or frequency domain. Hereafter, for brevity, the description is provided based on an irregular pattern in frequency domain. However, the solution may be extended for the case of irregular pattern in time domain and/or jointly irregular patterns in time and/or frequency domains. For example, an irregular pattern in frequency domain may be defined based on the sparsity of the channel, where the CSI configuration may include at least one of several factors.

The CSI configuration may include the configured bandwidth of CSI-RS-S (B_{CS}, e.g., in PRBs). A WTRU may be configured with a bandwidth of B_{CS}. This bandwidth may be independent of the frequency span of a scheduled transmission. In an example, the B_{CS} may be wider than or equal to the bandwidth of a scheduled transmission. When B_{CS} is narrower than the bandwidth of a scheduled transmission, the uplink precoders may be determined based on an extrapolation of the precoders determined from the CSI-RS-S within the configured B_{CS}.

The CSI configuration may include the information related to the mapping of CSI-RS-S in frequency domain (e.g., in REs, in RBs, etc.), by, e.g., a bitmap. A WTRU may receive mapping information related to the placement of CSI-RS-S within the configured BCS. For example, the WTRU may receive a bitmap as an indicator of the location of CSI-RS from a set of candidate locations. Additionally or alternatively, a WTRU may be configured with more than one pattern. The WTRU may then receive an indication and/or configuration of an index to select one of the configured patterns.

The CSI configuration may include the sparsity order information N_{SO}. A WTRU may receive an indication of a channel related parameter from which the CSI-RS-S pattern is derived. For example, a WTRU may receive the sparsity order of the channel N_{SO}. Then, according to the indicated and/or configured N_{SO}, the WTRU may determine the mapping of CSI-RS-S from a set of configured mappings.

The CSI configuration may include the rotation and/or shift parameter for the configured CSI-RS-S mapping. A rotated and/or a shifted version of a pattern may also be valid for transmission of CSI-RS-S. For example, a WTRU may determine which rotated and/or shifted version of the CSI-RS-S pattern to work with. Therefore, besides an indication of a CSI-RS mapping, the WTRU may also receive an indication of a rotation and/or shift parameter to apply on the indicated CSI-RS-S mapping.

The CSI configuration may include precoded CSI-RS-S. A WTRU may also receive an indication whether the received CSI-RS-S is precoded.

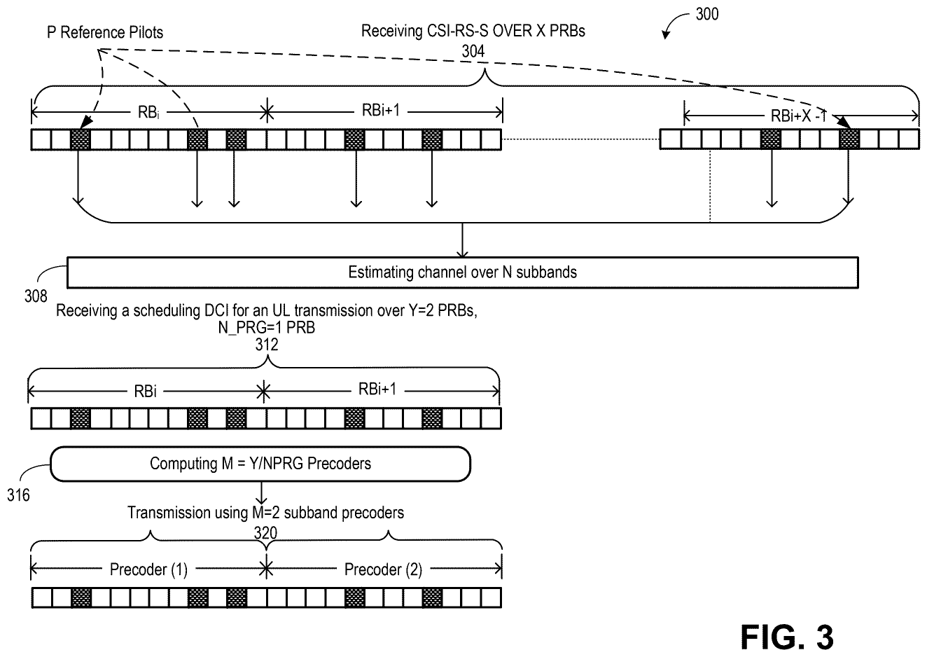

FIG. 3 depicts a process 300 for sparse CSI-RS-based TPMI determination by a wireless transmit/receive unit (WTRU). According to the configured CSI-RS-S, at 304, a WTRU may receive CSI-RS-S transmitted on P locations in frequency domain per layer over the configured bandwidth of CSI-RS-S (X). The transmission of the configured CSI-RS-S may be periodic, aperiodic, and/or semi-persistent mode.

At 308, the WTRU may determine the number of subband N for uplink precoders by dividing the configured bandwidth of CSI-RS-S (B_{CS}) by the subband size (N_{PRG}). If B_{CS}/N_{PRG} results in a non-integer value, a rounding function, (e.g., a ceiling functions, floor function, etc.) may be used.

Based on the received CSI-RS-S resource, and the sparsity order N_{SO}, a WTRU may proceed with at least one of the following steps: using the received CSI-RS-S mapped on P locations in frequency domain, the WTRU may first estimate the channel over the P locations. Then, using the P estimated channels, the WTRU may estimate the channel over N subbands, where the number of subbands may be larger than the number of available CSI-RS-S in frequency domain, e.g., N≥P. According to the Lmax, and/or using the estimated channel over the N subbands, the WTRU may also determine uplink precoders for each of N subbands.

At 312, a WTRU may receive a scheduling DCI for an uplink transmission over Y PRBs according to a configured and/or indicated rank (RI). The scheduled uplink transmission may be smaller than the configured CSI-RS-S, e.g., Y≤B_{CS}. When a WTRU receives a scheduling DCI for an uplink transmission with subband precoding, a WTRU may do at least one of the following:

For the scheduled UL transmission, at 316, the WTRU may divide the scheduled bandwidth Y into M subbands, where M, if not indicated in the scheduling DCI, is determined by division of the scheduled bandwidth (Y) by the subband size (N_{PRG}). If Y/N_{PRG} results in a non-integer value, a rounding function, (e.g., a ceiling functions, floor function, etc.) may be used. Additionally or alternatively, a WTRU may receive an indication for N_{PRG} and/or M in the scheduling DCI if neither is not configured or to override a configured value.

Then, using the estimated channel on P locations in frequency domain, a WTRU may estimate the channel over M subbands. The WTRU may determine the M uplink subband precoders for UL PUSCH transmission using one of the following approaches.

In one approach, the WTRU may first estimate the channel over N subband by relying on the estimated channel on P frequency locations. Then using the estimated channels, the WTRU may determine M (≥P) precoders for the scheduled transmission.

In another approach, the WTRU may first determine P precoders based on the estimated channel on P frequency locations. Then, based on the P determined precoders, the WTRU may determine M (≥P) subband precoders for the scheduled transmission.

In another approach, if a WTRU has received an indication that the received CSI-RS-S are precoded, the WTRU may determine subband precoders directly using the estimated channel based on the principle of channel reciprocity. However, when a WTRU has received an indication that the received CSI-RS-S are not precoded, the WTRU may determine subband precoders based on maximizing a metric (e.g., the capacity) of the channel experienced by CSI-RS-S. At 320, the WTRU may transmit the scheduled PUSCH using the determined precoder per subband.

A WTRU may receive a configuration to perform subband precoding for uplink transmission. The configuration may also include at least one of: precoding resolution that is the number of PRBs sharing a same precoding (N_{PRG}) and/or a maximum number of MIMO layer (Lmax).

The WTRU may receive a CSI-RS configuration (e.g., CSI-RS-S) where a RS is mapped based on the sparsity of the channel. The configuration may include at least one of the configured bandwidth of CSI-RS-S (B_{CS}, e.g., in PRBs); the information related to the mapping of CSI-RS-S in frequency domain (e.g., in REs), by e.g., a bitmap; the sparsity order information N_{SO}, from which the WTRU can determine the mapping of CSI-RS-S from a set of configured mappings; and/or the rotation/shift parameter for the configured CSI-RS-S mapping.

According to the configured CSI-RS-S, a WTRU may receive the CSI-RS-S transmitted on P locations in frequency domain per layer over the configured bandwidth of CSI-RS-S (X). The WTRU may determine the number of subband N, by dividing the configured bandwidth of CSI-RS-S (B_{CS}) by the subband size (N_{PRG}).

Based on the received CSI-RS-S resource, and/or the sparsity order N_{SO}, the WTRU may estimate the channel over N (≥P) subbands. According to the Lmax, the WTRU may also determine precoders for each of N subbands.

A WTRU may quantize and/or report the estimated CSI (e.g., channel estimate, uplink precoder, etc.) on P subbands, using at least one of the following methods: the WTRU may use direct quantization of elements (e.g., coefficients and/or entries of the channel matrix, its covariance matrix, and/or uplink precoder, etc.) of the estimated CSI. Then, WTRU may report P sets of quantized coefficients. Alternatively, the WTRU may use a codebook (e.g., a set of basis vectors, and/or a set of matrices, etc.) for quantization of the estimated CSI. Then, WTRU may report P sets of indices representing basis vectors and/or matrices.

From the received quantized CSI on P frequency locations, the gNB may determine CSI on M subband locations, where M is determined by dividing the scheduled bandwidth (Y) by the subband size N_{PRG}). The WTRU may receive a scheduling DCI that includes M TPMIs, e.g., one TPMIs per PRG, for an uplink transmission (e.g., PUSCH) over the scheduled uplink resource. The WTRU may transmit the scheduled uplink transmission (e.g., PUSCH) using the determined precoder per subband.

A WTRU may receive a semi-static and/or dynamic configuration and/or indication (e.g., by RRC, MAC-CE, and/or DCI) for applying and/or performing wideband precoding (e.g., low resolution precoding) or sub-band precoding (e.g., high resolution precoding) when precoding uplink transmissions, for example, when precoding PUSCH and/or PUCCH. The configuration may include one or more of the following indications:

The configuration may include an indication to perform wideband precoding or sub-band precoding. For example, the WTRU may receive an indication to switch from wideband precoding to sub-band precoding.

The configuration may include an indication to indicate the precoding resolution. For example, the number of frequency-units (e.g., N_{PRG}) or frequency-units size (N_{PRG}) sharing or using the same precoder.

In an example, the number of precoders and/or the number of frequency-units used by each precoder may be determined by the WTRU based on the number of precoders (P1) and the frequency-units (F1) (e.g., the number of PRBs in the configured bandwidth). This may be represented as N_{PRG}=F1/P1, or N_{PRG}=[F1/P1], or N_{PRG}=[F1/P1], where [(x)] and [(x)] are the mathematical ceiling and floor operations, respectively.

For example, when N_{PRG}<1, it may be interpreted, assumed, and/or understood that multiple precoders are being used for a single frequency unit. When N_{PRG}=F1/P1=1/2, the WTRU may use two precoders for a single sub-band. For example, the WTRU may use a first precoder for the first half of the sub-band and a second precoder for the second half of the sub-band.

The configuration may include an indication to indicate the maximum allowed and/or maximum supported number of MIMO transmission layers (e.g., Lmax) per frequency-unit, including the maximum allowed and/or maximum supported number of MIMO transmission layers per component carrier, per bandwidth part, per sub-band and/or per PRB.

The WTRU may receive a semi-static and/or dynamic configuration (e.g., by RRC, MAC-CE, and/or DCI) CSI-RS configuration (e.g., CSI-RS-S). The configuration may include one or more of the following:

An indication to indicate the frequency-unit(s) (e.g., bandwidth) for which or over which that wireless channel is to be estimated, calculated, or predicted using the measurement resource, (e.g., CSI-RS-S).

For example, the bandwidth has B_{CS} number of PRBs, sub-bands, or bandwidth parts. The WTRU may receive an indication indicating B_{CS}. The WTRU may receive a bitmap indicating the indices of the B_{CS} PRBs, sub-bands, and/or bandwidth parts in the bandwidth. Each bit in the bitmap may associate with a PRB. A ‘bit 1’ in the bitmap may indicate that the PRB is included in the bandwidth. A ‘bit 0’ may indicate that the PRB is not included in the bandwidth. The WTRU may receive an indication indicating the first PRB in the bandwidth and/or the last PRB in the bandwidth. Subtracting the index of the last PRB from the index of the first PRB may determine the number of PRBs included in the bandwidth. The WTRU may receive an indication indicating the first PRB in the bandwidth, the number of PRBs included in the bandwidth, and/or a PRB and/or sub-band offset. For example, the first PRB is 1, the number of PRBs in the bandwidth is 5, and the PRB offset is 2. Then, the WTRU may determine that the PRBs with indices 1, 3, 5, 7, and 9 may be included in the bandwidth.

The configuration may include indication(s) to indicate time and/or frequency domain resources. One or more CSI-RS resources (e.g., CSI-RS-S) may be transmitted by the gNB. The WTRU may receive one or more CSI-RS-S resource. The one or more CSI-RS-S resources may map based on the sparsity of the channel.

For example, a first CSI-RS-S resource may be mapped to a first bandwidth part. The first bandwidth part in this example may have 10 PRBs. The CSI-RS may be mapped to the 1st, 4th, and 8th PRBs. The WTRU may receive a first bitmap with a bitwidth equal to the number of PRBs in the bandwidth part, e.g., [1 0 0 1 0 0 0 1 0 0]. Here, bit value ‘1’ may indicate that the CSI-RS-S resource is mapped to the PRB. Bit value ‘0’ may indicate that the CSI-RS-S is not mapped to the PRB. The WTRU may receive a second bitmap with a bitwidth equal to the number of ‘1s’ in the first bitmap times the number of REs in each PRB. For example, each PRB may have 4 Res. The bitwidth of the second bitmap is 3*12=12 bits, e.g., [1 1 0 0 0 0 1 1 0 1 1 0]. This may indicate that the first CSI-RS-S resource maps to the 1st and/or 2nd REs in the 1st PRB, 3rd, and 4th REs in the 4th PRB and/or the 2nd and/or 3rd RE in the 8th PRB.

The WTRU may only receive the first indication (e.g., the first bitmap) indicating the frequency unit (e.g., PRBs) indices where the CSI-RS-S is mapped. The WTRU may assume (or alternatively receives a third indication) fixed indices of frequency units (e.g., REs) in each of the indicated PRBs where the CSI-RS-S may be mapped. For example, the WTRU may receive a first bitmap, e.g., [1 0 0 1 0 0 0 1 0 0]. The WTRU may now know that the CSI-RS-S resource(s) maps to the 1st, 4th, and/or 8th PRB. The WTRU may assume that the CSI-RS-S maps to the 1st and/or 2nd REs in the 1st, 4th, and/or 8th PRB. Additionally or alternatively, the WTRU may receive a first indication and/or a third indication. The WTRU may determine frequency-unit (e.g., RE) indices where a CSI-RS-S is mapped.

The WTRU may receive a first indication to indicate first frequency-units and/or a second indication to indicate the second frequency-units. The WTRU may use the first and/or the second frequency-units by the WTRU for reception of the CSI-RS-S resource(s). The first and/or the second indications may be based on an association rule that includes at least one sparsity-based parameter (e.g., sparsity order of the channel).

For example, the sparsity order of the channel is N_{SO}. Based on N_{SO}, the gNB may send a first and/or a second indication to the WTRU. The WTRU may receive a first and/or a second indication from the gNB, (e.g., a first codepoint associated with a first association rule and/or a second codepoint associated with a first or second association rule). The first and/or the second codepoints may indicate the time-units and/or the frequency-units that the gNB may use for transmission of one or more CSI-RS-S resources. For example, the first codepoint may indicate that the PRB indices. The second codepoint may indicates the RE indices. In another example, the first codepoint may indicate the PRB indices and/or the RE indices may be defined as fixed, e.g., the first few REs in the PRB may be used for mapping CSI-RS-S. Further, the second codepoint may indicate the RE indices. The PRB indices may be defined as fixed, e.g., the odd number or even number PRBs are used for mapping CSI-RS-S.

The first and/or second indications may apply to the one or more CSI-RS-S resources in the CSI-RS-S resource set. The WTRU may receive the first and/or second indication for a subset of CSI-RS-S resources in the CSI-RS-S resource set. For one or more of the remaining CSI-RS-S resources in the CSI-RS-S resource set, the WTRU may receive an offset value, a shift value, and/or a rotation factor in terms of time and/or frequency units. The WTRU may use the offset value, shift value, and/or rotation factor to determine the indexes of time-units and/or frequency-units for reception of the remaining CSI-RS-S resources in the CSI-RS-S resource set.

For example, the CSI-RS-S resource set may have 4 CSI-RS-S resources. The WTRU may receive a first and/or a second indication for the first CSI-RS-S resource. The WTRU may also receive an offset value, a shift value, and/or a rotation factor. Based on the first and/or second indication and/or the shift value associated with the second CSI-RS-S resource, the WTRU my determines the time-units and/or frequency units for reception of the second CSI-RS-S resource.

A single CSI-RS-S resource may be transmitted in chunks, parts, portions, and/or segments of time-units and/or frequency units (e.g., code division multiplexing (CDM) groups). For example, the CSI-RS-S resource may have multiple CDM groups. The WTRU may receive the CSI-RS-S resource at different segments and/or portions of time-units and/or frequency-units. The WTRU may receive the above-mentioned first and/or second indication for one or more CDM groups of one or more CSI-RS-S resources in the CSI-RS-S resource set. For one or more of the remaining CDM groups, the WTRU may receive an offset value, a shift value, and/or a rotation factor in terms of time and/or frequency units. The WTRU may use the offset value, shift value, and/or rotation factor to determine the indexes of time-units and/or frequency-units for reception of the remaining CDM groups of the CSI-RS-S resource.

For example, the CSI-RS-S resource has 4 CDM groups. The WTRU may receive a first and/or a second indication for the first CDM group. The WTRU may also receive an offset value, a shift value, and/or a rotation factor. Based on the first and/or second indication and the shift value associated with the second CSI-RS-S resource, the WTRU may determine the time-units and/or frequency units for reception of the second CDM group of the CSI-RS-S resource.

The gNB may use one or more transmission layers (e.g., spatial domain layers) to transmit one or more CSI-RS-S resources. The WTRU may use one or more transmission layers by the WTRU to receive one or more CSI-RS-S resources. The two or more transmission layers may use the same or different frequency-units for transmission of the CSI-RS-S resources. When different frequency-units across the transmission layers are used for transmission of the CSI-RS-S resources, the above-mentioned indications and/or solutions (e.g., the first indication, the second indication, and/or the shift value) for frequency-units indication for a CSI-RS-S resource and/or for a CDM group may also be used for indication of frequency-unit for different transmission layers.

According to the configuration, the WTRU may do one or more of the following regarding CSI quantities and their association with resource units: the WTRU may receive one or more CSI-RS-S resources at one or more frequency-units, e.g., at P PRBs and/or at P sub-bands within the configured bandwidth for the CSI-RS-S. The WTRU may receive one or more CSI-RS-S resources using one or more layers, e.g., using at P PRBs and/or at P sub-bands within the configured bandwidth for the CSI-RS-S. The P frequency-unit locations across the multiple layers may be the same or different.

The WTRU may determine the number of quantities (e.g., precoders and/or channel quality indexes (Qis)) N based on the configured bandwidth for the CSI-RS-S, B_{CS} The determination may be based on the configured number of frequency units (e.g., sub-bands) N_{PRG} sharing the same precoding and/or a WTRU capability-based parameters, e.g., a.

For example, the number of quantities is N=B_{CS}/(axNPRG), or N=┌B_{CS}/(α×N_{PRG})┐, or N=└B_CS/(α×N_{PRG}┘. A smaller value of α implies that the WTRU may estimate a larger number of quantities for the configured bandwidth B_{CS}. A larger value of α implies that the WTRU may estimate a smaller number of quantities for the configured bandwidth B_{CS}. The WTRU may declare its supported capability value, α to the gNB. The WTRU may send its α value to the gNB.

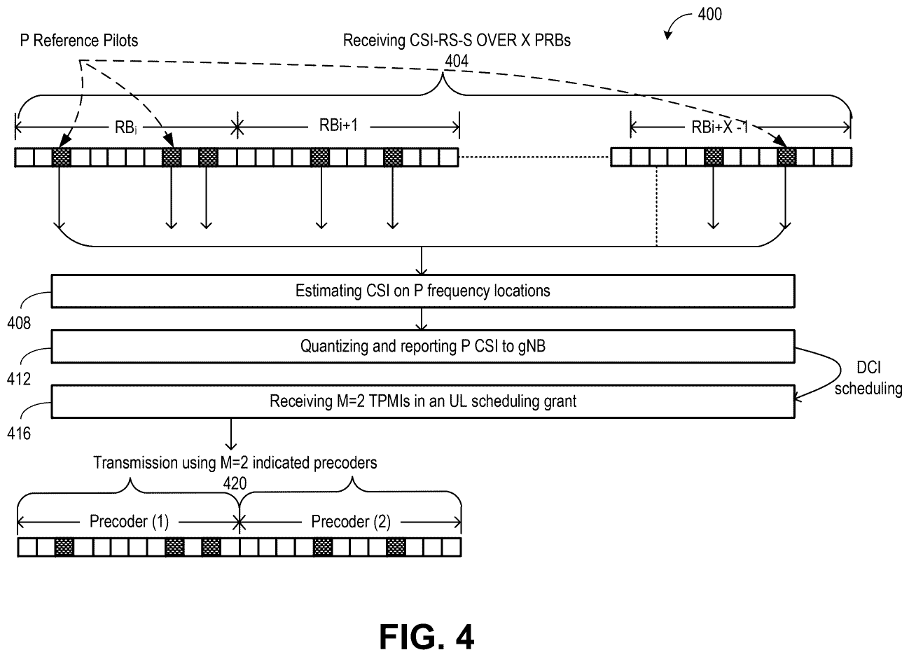

FIG. 4 depicts a process 400 for sparse CSI-RS-based TPMI determination by a network (e.g., gNB). A WTRU may receive a configuration to perform subband precoding for uplink transmission. The configuration may also include at least one of: precoding resolution that is the number of PRBs sharing a same precoding (N_{PRG}) and/or a maximum number of MIMO layer (Lmax).

The WTRU may receive a CSI-RS configuration (e.g., CSI-RS-S) where a RS is mapped based on the sparsity of the channel. The configuration may include at least one of the configured bandwidth of CSI-RS-S (B_{CS}, e.g., in PRBs); the information related to the mapping of CSI-RS-S in frequency domain (e.g., in REs), by e.g., a bitmap; the sparsity order information N_{SO}, from which the WTRU can determine the mapping of CSI-RS-S from a set of configured mappings; and/or the rotation/shift parameter for the configured CSI-RS-S mapping.

According to the configured CSI-RS-S, a WTRU may receive the CSI-RS-S transmitted on P locations in frequency domain per layer over the configured bandwidth of CSI-RS-S (X). The WTRU may determine the number of subband N, by dividing the configured bandwidth of CSI-RS-S (B_{CS}) by the subband size (N_{PRG}).

Based on the received CSI-RS-S resource, and/or the sparsity order N_{SO}, the WTRU may estimate the channel over N (≥P) subbands. According to the Lmax, the WTRU may also determine precoders for each of N subbands.

A WTRU may quantize and/or report the estimated CSI (e.g., channel estimate, uplink precoder, etc.) on P subbands, using at least one of the following methods: the WTRU may use direct quantization of elements (e.g., coefficients and/or entries of the channel matrix, its covariance matrix, and/or uplink precoder, etc.) of the estimated CSI. Then, WTRU may report P sets of quantized coefficients. Alternatively, the WTRU may use a codebook (e.g., a set of basis vectors, and/or a set of matrices, etc.) for quantization of the estimated CSI. Then, WTRU may report P sets of indices representing basis vectors and/or matrices.

From the received quantized CSI on P frequency locations, the gNB may determine CSI on M subband locations, where M is determined by dividing the scheduled bandwidth (Y) by the subband size N_{PRG}). The WTRU may receive a scheduling DCI that includes M TPMIs, e.g., one TPMIs per PRG, for an uplink transmission (e.g., PUSCH) over the scheduled uplink resource. The WTRU may transmit the scheduled uplink transmission (e.g., PUSCH) using the determined precoder per subband.

Based on the received CSI-RS resource(s) and the sparsity order (N_{SO}), as demonstrated in FIG. 4, the WTRU may do one or more of the following: at 404, the WTRU may receive CSI-RS-S resource(s) at P number of frequency-units. The WTRU may estimate, determine, or predict the wireless channel over N number of frequency units, where N≥P. N may also be N<P. For example, at 408, the WTRU may estimate the wireless channel for N number of sub-bands while measuring a measurement resource, e.g., CSI-RS-S at P sub-band locations.

The WTRU channel estimation, determination, and/or prediction may include channel impulse response, or the gain of the channel between the gNB and the WTRU. The channel impulse response may also correspond to the channel gain between the CSI-RS-S ports and the receiving antenna ports, e.g., the SRS ports or coefficients of the channel matrix determined using the CSI-RS-S received at P frequency units. The WTRU channel estimation, determination, and/or prediction may include channel quality; specifically, a value of the channel quality, such as a sub-band and/or wideband CQI. The WTRU channel estimation, determination, and/or prediction may include a precoder, e.g., from a codebook of pre-defined precoders. The precoder(s) may be sub-band precoders and/or wideband precoder.

When sub-band CQI and/or sub-band precoder determination and/or reporting is configured, the maximum number of determined CQIs and/or the maximum number of determined precoders may be based on WTRU capability a. For example, when B_{CS}=10, N_{PRG}=5 and α=4, the WTRU may determine 2 CQI for a single sub-band and/or 2 precoders for a single sub-band. The first of the 2 precoders and/or the first of the 2 CQIs may be associated with the first half of the sub-band and the second of the 2 precoders or the second of the 2 CQIs may be associated with the second half of the sub-band.

The WTRU channel estimation, determination, and/or prediction may include a rank indicator. The precoder(s) e.g., wideband precoders and/or sub-band precoders may be determined for a rank value. For example, the determined precoder may be based on a number of layers less than the configured maximum number of MIMO layers Lmax.

At 412, the WTRU may quantize the determined quantities using a quantization rule. The quantization rule(s) may be quantity specific, e.g., a quantization rule for coefficients quantization, channel covariance matrix quantization, and/or CQI quantization, etc. The quantization of the CSI may be based on a rule or an equation. The rule and/or equation may include a channel sparsity-based parameter or variable, (e.g., the channel sparsity order). The quantization rule(s) and/or one or more parameters or variables of the quantization rule may be semi-statically and/or dynamically configured (e.g., by radio resource control (RRC), medium access control (MAC) control element (CE), and/or DCI). Additionally or alternatively, the quantization rule(s) may be pre-defined and/or defined as fixed.

The WTRU may quantize the channel coefficients, or the elements of the covariance matrix based on the strength of the channel coefficient or the elements of the covariance matrix.

For example, the difference between two quantized channel coefficients is smaller if the actual two coefficients are stronger. The difference between the two quantized channel coefficient is smaller if the actual two coefficients are weaker. Therefore, that stronger coefficients may be sampled closer to each other as compared to weaker coefficients.

The WTRU may quantize the determined precoders using a quantization rule. The quantization rule may be based on and/or include variables and/or parameters related to direction specific information from the gNB to the WTRU, e.g., azimuth and/or downtilt. The quantization rule may be based on and/or include variable and/or parameters related to the sparsity of the channel. The gNB may indicate that the direction specific information and/or the sparsity-based information may be semi-statically and/or dynamically configured and/or indicated to the WTRU. The WTRU may quantize the precoders with a higher resolution in the specified direction and/or the specified sparsity values of the channel.

The WTRU may determine one or more precoders from a configured, indicated, and/or pre-defined as fixed codebook of precoders. The codebooks may be designed and/or defined based on the sparsity order of the channel. The WTRU may select a codebook for precoder selection based on the configured or indicated sparsity order of the channel, e.g., based on N_{SO}. For example, when the sparsity order is large, the codebook may be a higher resolution codebook. When the sparsity order is small, the codebook may be a lower resolution codebook.

The WTRU may send a CSI report that includes the CSI determined for N frequency-units while measuring CSI-RS-S at P frequency-unit locations. The CSI report may be sent over along with data, hybrid automatic request acknowledgement, not acknowledgment (HARQ ACK/NACK) or without data, HARQ ACK/NACK. When sending the CSI report, the WTRU may do one or more of the following:

When the WTRU is configured to send (and/or report) a CSI report that includes CSI indications based on measurements of two different resource(s), (e.g., based on a first CSI-RS-S with an associated first sparsity order and a second CSI-RS-S with an associated second sparsity order), the WTRU may prioritize the CSI contents associated with a first sparsity order over the CSI contents associated with the second sparsity order.

The WTRU may send two or more CSI reports where one or more CSI reports may associate with a sparsity order N_{SO} and/or the reporting resources configured for the two or more CSI report may collide in at least one time and frequency units. In such instances, the WTRU may, for example, the gNB schedules a first CSI report associated with a first sparsity order and/or a second CSI report associated with a second sparsity order. The resources for the first CSI report and/or the second CSI report for reporting has at least one common or same time unit, e.g., a symbol. The resources may include a frequency unit, (e.g., a subcarrier), which the WTRU may prioritize transmission and/or sending of the first CSI report over the second CSI report or the second CSI report over the first CSI report based on the associated sparsity order values.

Regarding updated CSI, uplink scheduling, and/or uplink transmissions the gNB may receive the CSI reported by the WTRU. The gNB may change, modify, and/or update the CSI, or keep it un-changed, such as when the gNB determines a new CSI based on the reported CSI from the WTRU. For example, the gNB may determine M precoders for a frequency-unit(s) (Y), (e.g., bandwidth Y), based on the received N precoders, where N≤P or N may also be N>P. The number of precoders M for a bandwidth Y may be determined based on the precoding resolution N_{PRG}, the WTRU capability a and/or N, (e.g., M=Y/N_{PRG}).

At 416, the WTRU may receive a scheduling DCI. The DCI may include one or more of the following: a first, second, third, and/or fourth field, where the first, second, third, and/or fourth fields may be an existing field or a new field.

The first field may indicate if the WTRU should use the reported precoder (e.g., TPMIs) or if the gNB is sending new TPMIs. For example, the first field may have a single bit indication. The value of the first field as ‘1’ may imply that the WTRU should use the reported precoders. A field value is ‘0’ may imply that the WTRU should receive a new set of precoders using the second field. The second field may indicate a set of precoders, (e.g., M precoders). The second field may not be present in the DCI if the value of the first field is ‘1’. The third field may indicate time and/or frequency resource, (e.g., Y number of frequency-units) to the WTRU for uplink transmission, (e.g., a physical uplink shared channel (PUSCH)). The fourth field may indicate to the WTRU the frequency-unit indexes associated with each of the WTRU determined N precoders and/or gNB indicated M precoders. Additionally or alternatively, the WTRU may determine the frequency indexes associated with each of the WTRU determined N precoders. A gNB may indicate M precoders based on the scheduled bandwidth with Y number of frequency units. At 420, the WTRU may perform a scheduled uplink transmission (e.g., PUSCH) over the uplink resources using the WTRU determined precoders or the indicated precoders.

A WTRU may determine sparse signaling reference signal (SRS)-based TPMI. A WTRU may receive a configuration to perform subband precoding for uplink transmission. For example, the configuration may also include at least a precoding resolution that is the number of PRBs sharing a same precoding (N_{PRG}). The WTRU may receive an SRS configuration (e.g., SRS-S) by which L-port SRS resource(s) may be mapped based on the sparsity of the channel.

The configuration may include at least one of: the configured bandwidth of SRS-S (B_{CS}, e.g., in PRBs); the information related to the mapping of SRS-S resource in frequency domain by, e.g., a bitmap (e.g., in REs, and/or PRBs, etc.); the sparsity order information N_{SO}, from which the WTRU may determine the mapping of SRS-S from a set of configured mappings; and/or the rotation and/or shift parameter for the configured SRS-S mapping. For example, the configured SRS-S resource(s) may be mapped on P locations in frequency domain with (e.g., irregular) spacing in frequency domain over B_{CS}.

The WTRU may receive a trigger (e.g., by a DCI) to transmit SRS on the P different locations in frequency domain. From the received SRS-S transmissions on P frequency locations, the gNB may determine P TPMIs according to N_{PRG}. The WTRU may receive a scheduling DCI that includes P TPMIs for an uplink transmission (e.g., PUSCH) over the M scheduled subbands. Division of the scheduled bandwidth (Y) by the subband size N_{PRG} may determine The M scheduled subbands. The WTRU may determine the remaining (M-P) TPMIs for transmission on the indicated uplink resources (e.g., PRBs) per configured and/or indicated N_{PRG}. The WTRU may transmit the scheduled uplink transmission (e.g., PUSCH), using the determined precoder per subband.

A WTRU may receive a configuration for subband precoding for uplink transmission, where the configuration may comprise information on precoding resolution that is the number of PRBs sharing a same precoding (N_{PRG}). For a scheduled PUSCH, the WTRU may determine M subband (SB) TPMIs (e.g., as a final form of SB TPMIs to be applied for a PUSCH transmission) based on a received P (P<=M) SB TPMIs indicated by the gNB (e.g., via a bit field in a DCI). In the following, we describe the detailed steps for an SRS-based TPMI determination by the WTRU. The term TPMI may be interchangeably used with the term precoding indicators.

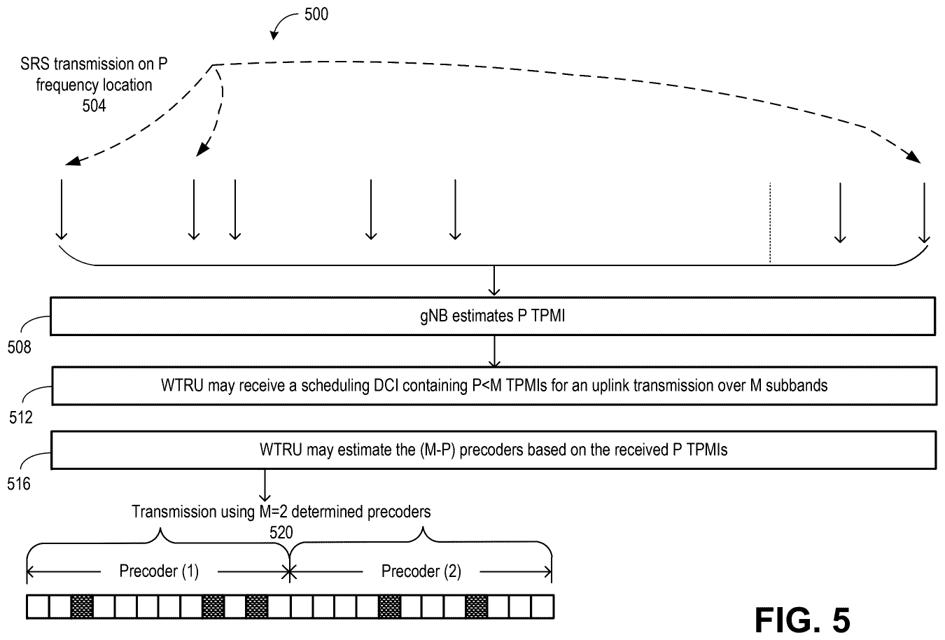

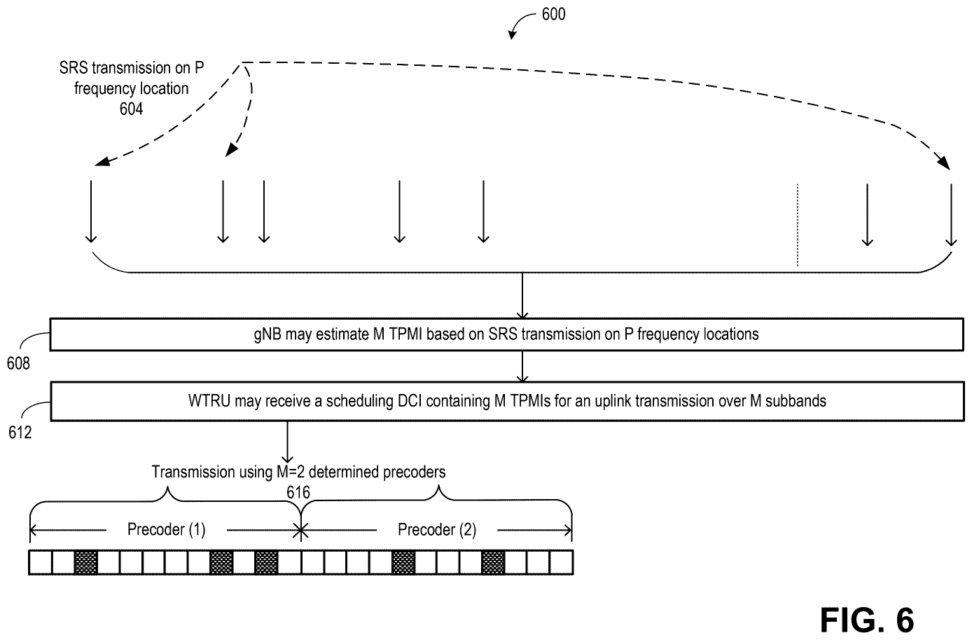

The WTRU may signal a capability that it supports frequency selective UL precoding (e.g., more than one precoder in the frequency domain per BWP). The WTRU may optionally signal one or more supported precoding resolutions. The resolution may determine the number of resources in the frequency domain (e.g., RBs and/or SBs) over which the WTRU may apply a precoder. The WTRU may receive a configuration of the precoding resolution, N_{PRG}. The precoding resolution, N_{PRG} may indicate the number of consecutive RBs over which the WTRU may apply a precoder. For a given resource allocation of a bandwidth Y, the WTRU may apply M TPMIs where M is equal to the bandwidth Y divided by the precoding resolution, N_{PRG}. The configuration may indicate if the WTRU or gNB may determine the SRS-based TPMI (e.g., configured for the scheme in FIG. 5 and/or FIG. 6).

The WTRU may receive a configuration of an SRS-S resource set. The SRS-S resource set may indicate one or more L-port SRS resources. The network may configure the SRS-S resource set based on measurements on other RS (e.g., downlink and/or uplink) which the WTRU and/or network may use to determine the sparsity order of the channel, N_{SO}. The WTRU may be configured with a set of SRS-S resources. The WTRU may determine a subset of SRS-S resource mappings in the time and/or frequency domain based on the determined sparsity order. For example, the sparsity order may indicate a mapping of SRS-S resource in frequency domain by, e.g., a bitmap (e.g., in REs and/or PRBs, etc.). The bitmap may indicate the subset of resources over which the WTRU transmits the SRS-S for a given N_{SO}. The bitmap may indicate contiguous and/or non-contiguous locations. For example, the configured SRS-S resource(s) is mapped on P locations in frequency domain with (e.g., irregular) spacing in frequency domain over BCS. The WTRU may determine other SRS-S resource configurations as a function of the sparsity order such as the configured bandwidth of SRS-S (B_{CS}, e.g., in PRBs) and the rotation and/or shift parameter for the configured SRS-S mapping. Therefore, the configuration may yield an SRS-S resource set with SRS-S resources each of which the WTRU may transmit on the P determined locations in the frequency domain. Based on the sparsity order, the SRS may be transmitted over a number of resources much smaller than the overall bandwidth (e.g., P<<Y).

The SRS-S resource set may be configured as periodic. In this case, the resource set may be configured with a periodicity, T_{SRS}, and the WTRU transmits the SRS-S resources from the set periodically every T_{SRS} seconds. The SRS-S resource set may be configured as semi-persistent (SP) and/or aperiodic (AP). In these cases, each SRS-S resource may be configured with a trigger state (e.g., a number). The WTRU may receive a DCI which includes a bitfield corresponding to one or more trigger states and/or a time offset per SRS-S resource starting from the triggering DCI. After receiving the triggering DCI for SP, the WTRU may periodically transmit the SRS-S starting after the offset until receiving another DCI to deactivate the SP resources. After receiving the triggering DCI for AP, the WTRU may transmit the SRS-S resources in one transmission occasion in a slot after the offset.

The WTRU may transmit one or more SRS-S resources over the P locations in the frequency domain. The network may determine the precoders based on the P locations (e.g., not over the entire bandwidth Y). The network may determine the precoders (e.g., P precoders) from a codebook of precoders, where the index of one precoder from the codebook may be indicated by a TPMI (e.g., in a DCI). The codebook of TPMIs is preconfigured at the WTRU so that the network may indicate the TPMI to the WTRU (e.g., the P precoders) and the WTRU may derive remaining (M-P) TPMIs for transmission on the indicated UL resource (PRBs), e.g., per configured/indicated N_{PRG}. The WTRU may transmit the scheduled PUSCH using the determined precoder per subband.

FIG. 5 depicts a process 500 for sparse SRS-based transmitted precoding matrix indicator (TPMI) determination by a WTRU. A WTRU may receive a configuration to perform subband precoding for uplink transmission. For example, the configuration may also include at least a precoding resolution that is the number of PRBs sharing a same precoding (N_{PRG}). The WTRU may receive an SRS configuration (e.g., SRS-S) by which L-port SRS resource(s) may be mapped based on the sparsity of the channel.

The configuration may include at least one of: the configured bandwidth of SRS-S (B_{CS}, e.g., in PRBs); the information related to the mapping of SRS-S resource in frequency domain by, e.g., a bitmap (e.g., in REs, and/or PRBs, etc.); the sparsity order information N_{SO}, from which the WTRU may determine the mapping of SRS-S from a set of configured mappings; and/or the rotation and/or shift parameter for the configured SRS-S mapping. For example, the configured SRS-S resource(s) may be mapped on P locations in frequency domain with (e.g., irregular) spacing in frequency domain over B_{CS}.

The WTRU may receive a trigger (e.g., by a DCI) to transmit SRS on the P different locations in frequency domain. From the received SRS-S transmissions on P frequency locations, the gNB may determine P TPMIs according to N_{PRG}. The WTRU may receive a scheduling DCI that includes P TPMIs for an uplink transmission (e.g., PUSCH) over the M scheduled subbands. Division of the scheduled bandwidth (Y) by the subband size N_{PRG} may determine The M scheduled subbands. The WTRU may determine the remaining (M-P) TPMIs for transmission on the indicated uplink resources (e.g., PRBs) per configured and/or indicated N_{PRG}. The WTRU may transmit the scheduled uplink transmission (e.g., PUSCH), using the determined precoder per subband.

As illustrated in FIG. 5 at 504, the WTRU may first send the SRS-S(on P frequency location) to aid the network in estimating the channel and determining the P TPMIs. At 512, the network may then schedule the WTRU with a DCI and/or indicate the P TPMIs for precoding the PUSCH over M subbands (e.g., M>=P). At 516, The WTRU may determine the remaining (M-P) precoders based on the received P TPMIs. At 520, the WTRU may then transmit the PUSCH using the determined (M) TPMIs over the M subbands. The DCI may include an FDRA bit field (or a modified frequency domain resource assignment (FDRA) field) which indicates the scheduled P (e.g., P<=M) subbands explicitly. This may provide benefits in terms of overhead reduction by signaling only P TPMIs from the network. This is an alternative to signaling total M TPMIs (M>=P) for a scheduled PUSCH with subband precoding, where the WTRU may determine the remaining (M-P) TPMIs based on the indicated P TPMIs.

A gNB may determine sparse SRS-based TPMI. A WTRU may receive a configuration to perform subband precoding for uplink transmission. The configuration may also include a precoding resolution that is the number of PRBs sharing a same precoding (N_{PRG}). The WTRU may receive an SRS configuration (e.g., SRS-S) by which L-port SRS resource(s) are mapped based on the sparsity of the channel, where the configuration may include at least one of: the configured bandwidth of SRS-S (B_{CS}, e.g., in PRBs); the information related to the mapping of SRS-S resource in frequency domain by, e.g., a bitmap (e.g., in REs and/or PRBs, etc.); the sparsity order information N_{SO}, from which the WTRU may determine the mapping of SRS-S from a set of configured mapping; and/or the rotation and/or shift parameter for the configured SRS-S mapping. For example, the configured SRS-S resource(s) may be mapped on P locations in frequency domain with (e.g., irregular) spacing in frequency domain over B_{CS}.

The WTRU may receive a trigger (e.g., by a DCI) to transmit SRS on the P different locations in frequency domain. From the received SRS-S transmissions on P frequency locations, the gNB may determines all M TPMIs, where M is determined by division of the scheduled bandwidth (Y) by the subband size N_{PRG} The WTRU may receive a scheduling DCI that includes M TPMIs, e.g., one TPMI per PRG, for an uplink transmission (e.g., PUSCH) over the scheduled uplink resource. The WTRU may transmit the scheduled PUSCH, using the indicated precoder per subband.

The SB TPMIs may be determined by the gNB based on SRS-S transmissions from the WTRU. The WTRU may transmit a physical channel (e.g., PUSCH) where the WTRU applies a SB TPMI based on an indication from the gNB (e.g., bit field in a DCI). In the following, we describe the detailed steps for an SRS-based TPMI determination by the gNB. TPMI may be interchangeably used with precoding indicators.

The WTRU may signal a capability that it supports frequency selective UL precoding (e.g., more than one precoder in the frequency domain per BWP), and the WTRU may optionally signal one or more supported precoding resolutions, where the resolution determines the number of resources in the frequency domain (e.g., RBs or SBs) over which the WTRU may apply a precoder. The WTRU may receive a configuration of the precoding resolution, NPRG, which indicates the number of consecutive RBs over which the WTRU may apply a precoder. For a given resource allocation of a bandwidth Y, the WTRU may apply M TPMIs where M is equal to the bandwidth Y divided by the precoding resolution, NPRG. The configuration may indicate if the SRS-based TPMI should be determined by the WTRU or the gNB (e.g., configured for the scheme in FIG. 5 and/or FIG. 6).

The WTRU may receive a configuration of an SRS-S resource set which indicates one or more L-port SRS resources. The network may configure the SRS-S resource set based on measurements on other RS (DL or UL) which the WTRU and network may use to determine the sparsity order of the channel, NSO. The WTRU may be configured with a set of SRS-S resources. The WTRU may determine a subset of SRS-S resource mappings in the time/frequency domain based on the determined sparsity order. For example, the sparsity order may indicate a mapping of SRS-S resource in frequency domain by, e.g., a bitmap (e.g., in REs, PRBs, etc.). The bitmap indicates the subset of resources over which the WTRU transmits the SRS-S for a given NSO. The bitmap may indicate contiguous or non-contiguous locations. For example, the configured SRS-S resource(s) is mapped on P locations in frequency domain with (e.g., irregular) spacing in frequency domain over BCS. The WTRU may determine other SRS-S resource configurations as a function of the sparsity order such as the configured bandwidth of SRS-S (BCS, e.g., in PRBs) and the rotation/shift parameter for the configured SRS-S mapping. Therefore, the configuration yields an SRS-S resource set with SRS-S resources each of which the WTRU may transmit on the P determined locations in the frequency domain. Based on the sparsity order, the SRS is transmitted over a number of resources that is much smaller than the overall bandwidth (e.g., P<<Y).

The SRS-S resource set may be configured as periodic. In this case, the resource set may be configured with a periodicity, T_{SRS}. The WTRU may transmit the SRS-S resources from the set periodically every T_{SRS} seconds. The SRS-S resource set may be configured as semi-persistent (SP) or aperiodic (AP). In these cases, each SRS-S resource is configured with a trigger state (e.g., a number). The WTRU may receive a DCI which includes a bitfield corresponding to one or more trigger states and/or a time offset per SRS-S resource starting from the triggering DCI. After receiving the triggering DCI for SP, the WTRU may periodically transmit the SRS-S starting after the offset until receiving another DCI to deactivate the SP resources. After receiving the triggering DCI for AP, the WTRU may transmit the SRS-S resources in one transmission occasion in a slot after the offset.

The WTRU may transmit one or more SRS-S resources over the P locations in the frequency domain. The network may determine the precoders over the entire bandwidth Y. The network may determine the precoders from a codebook of precoder. The index of one precoder from the codebook may be indicated by a TPMI (e.g., in a DCI). The codebook of TPMIs may be preconfigured at the WTRU so that the network may indicate the TPMI to the WTRU for precoding a PUSCH transmission. In one solution, the wideband (WB) and/or frequency-selective uplink precoding transmission mode may be preconfigured as part of the PUSCH configuration. If the PUSCH is preconfigured for WB, the WTRU may receive a DCI with one TPMI that may be applied over the entire bandwidth. If the PUSCH is preconfigured for frequency-selective UL precoding, the WTRU may expect to receive a DCI with a fixed number of preconfigured TPMIs, M.

FIG. 6 depicts a process 600 for sparse SRS-based TPMI determination by a network (e.g., gNB). A WTRU may receive a configuration to perform subband precoding for uplink transmission. The configuration may also include a precoding resolution that is the number of PRBs sharing a same precoding (N_{PRG}). The WTRU may receive an SRS configuration (e.g., SRS-S) by which L-port SRS resource(s) are mapped based on the sparsity of the channel, where the configuration may include at least one of: the configured bandwidth of SRS-S (B_{CS}, e.g., in PRBs); the information related to the mapping of SRS-S resource in frequency domain by, e.g., a bitmap (e.g., in REs and/or PRBs, etc.); the sparsity order information N_{SO}, from which the WTRU may determine the mapping of SRS-S from a set of configured mapping; and/or the rotation and/or shift parameter for the configured SRS-S mapping. For example, the configured SRS-S resource(s) may be mapped on P locations in frequency domain with (e.g., irregular) spacing in frequency domain over B_{CS}.

The WTRU may receive a trigger (e.g., by a DCI) to transmit SRS on the P different locations in frequency domain. From the received SRS-S transmissions on P frequency locations, the gNB may determines all M TPMIs, where M is determined by division of the scheduled bandwidth (Y) by the subband size N_{PRG} The WTRU may receive a scheduling DCI that includes M TPMIs, e.g., one TPMI per PRG, for an uplink transmission (e.g., PUSCH) over the scheduled uplink resource. The WTRU may transmit the scheduled PUSCH, using the indicated precoder per subband.

FIG. 6, at 604, illustrates a mode of operation where the WTRU first sends the SRS-S to aid the network in estimating the channel at 608 and/or determining the TPMIs. At 612, the network may then schedule the WTRU with a DCI. The network may indicate the M TPMIs for precoding the PUSCH over M subbands. At 616, the WTRU then may transmit the PUSCH using the determined TPMIs over the M subbands. The DCI may include an FDRA bit field which indicates the scheduled M subbands explicitly with a bit field of length equal to the bandwidth, and M of the bits are equal to 1 for a scheduled SB index. In this configuration, the size of the SBs is fixed and/or preconfigured. Additionally or alternatively, the WTRU may receive a modified FDRA for frequency-selective scheduling where the bit field is partitioned in two sections. The first section (e.g., the first S1 significant bits of the FDRA) may map to a SB size (e.g., N_{PRG}). The second section may map to a bitfield indicating the SB indices where a bit is equal to 1 for every scheduled SB.

The DCI may dynamically switch between WB and frequency-selective UL precoding. An explicit bit field in the DCI may be used to indicate which of the two precoding schemes is used. To facilitate the blind decoding of the DCI, the number of bits in the TPMI field may be preconfigured to a fixed number of bits. However, the WTRU may interpret the TPMI field as a function of the bit indicating WB or frequency-selective UL precoding. The WTRU may partition and/or interpret the TPMI field into multiple TPMIs. For example, the TPMI bit field may consist of B bits, and a switching bit that is either 0 or 1. If the switching bit is 0, the WTRU may interpret the entire TPMI B bits as mapping to one precoder applied over the entire bandwidth. If the bit is 1, the WTRU may interpret the TPMI B bits as multiple TPMIs where the bit field is partitioned into M precoders (e.g., M concatenated bit fields of B/M bits each). The WTRU may map each of the M precoders onto the resource allocation based on a pre-determined rule (e.g., in increasing index of resource allocation). Additionally or alternatively, the WTRU may determine the partition of the B bits in the TPMI field into multiple bitfields for SB precoders as a function of explicit bits in the DCI (e.g., the dynamic switching indication). For example, two bits may be used where 00 indicates WB precoding, 01 indicates SB precoding with 2 precoders (B/2 bits per precoder), 10 indicates SB precoding with 3 precoders (B/3 bits per precoder), and/or 11 indicates SB precoding with 4 precoders (B/4 bits per precoder).

The WTRU may receive a MAC-CE to activate and/or deactivate frequency-selective precoding. If the MAC-CE activates frequency-selective precoding, the WTRU may interpret the TPMI field with B bits as a concatenation of multiple TPMIs where each TPMI corresponds to a subset of the bandwidth. If the MAC-CE deactivates frequency-selective precoding, the WTRU may interpret the TPMI field with B bits as a single TPMI. The WTRU may receive more than one codebook configuration for the precoders. A first codebook may be designed for WB precoding, and a second codebook may be designed for frequency-selective precoding. The TPMI for WB precoding may map to the first precoding codebook. The TPMIs for frequency-selective precoding may map to the second precoding codebook. The WTRU may determine which codebook to map the TPMI as a function of the PUSCH precoding transmission mode (e.g., WB or frequency-selective). The WTRU may be preconfigured, dynamically switched through a DCI, or semi-statically configured through a MAC-CE.

What is claimed is:

1. A wireless transmit/receive unit (WTRU) comprising:
a processor configured to:
receive a reference signal (RS) configuration, wherein the RS configuration comprises an indication of a plurality of RSs mapped in an irregular pattern in a channel over a plurality of subbands, wherein the RS configuration comprises information associated with the irregular pattern;
estimate a channel information over the plurality of subbands that comprise no RSs, based on the one or more RSs mapped in the irregular pattern and the information associated with the irregular pattern;
receive downlink control information (DCI), wherein the DCI comprises an indication of an uplink transmission and an indication of the subbands within the plurality of subbands available for the uplink transmission;
determine, per each subband within the plurality of subbands, uplink precoders for the scheduled uplink transmission based on the estimation; and
send the uplink transmission using the uplink precoders.

2. The WTRU of claim 1, wherein the irregular pattern comprises a plurality of RSs that are not uniformly distributed throughout the channel.

3. The WTRU of claim 1, wherein the irregular pattern comprises a plurality of RSs that are not evenly spaced throughout the channel.

4. The WTRU of claim 1, wherein the RS configuration comprises one or more of the configured bandwidth of the RSs, an indication of the mapping of the RSs in a frequency domain, or a rotation value of the irregular pattern.

5. The WTRU of claim 4, wherein the processor is further configured to:
determine, by dividing the configured bandwidth of the RSs with a size of the subband on the channel for estimation, the number of subbands within the plurality of subbands on the channel for estimation.

6. The WTRU of claim 4, wherein the indication of the mapping of the RSs in a frequency domain comprises a bitmap, wherein the bitmap indicates the location of the RSs from a set of candidate locations.

7. The WTRU of claim 4, wherein the configured bandwidth of the RSs is wider than or equal to a bandwidth associated with the uplink transmission.

8. The WTRU of claim 1, wherein the information associated with the irregular pattern is a sparsity order.

9. The WTRU of claim 1, wherein the determination of the uplink precoders is based on a plurality of frequency locations within the plurality of subbands that comprise no RSs.

10. The WTRU of claim 1, wherein the processor is further configured to:
receive configuration information, wherein the configuration information comprises one or more of a precoding resolution or an indication of a maximum number of multiple input multiple output (MIMO) layers.

11. A method implemented by a wireless transmit/receive unit (WTRU), the method comprising:
receiving a reference signal (RS) configuration, wherein the RS configuration comprises an indication of a plurality of RSs mapped in an irregular pattern in a channel over a plurality of subbands, wherein the RS configuration comprises information associated with the irregular pattern;
estimating a channel information over the plurality of subbands that comprise no RSs, based on the one or more RSs mapped in the irregular pattern and the information associated with the irregular pattern;
receiving downlink control information (DCI), wherein the DCI comprises an indication of an uplink transmission and an indication of the subbands within the plurality of subbands available for the uplink transmission;
determining, per each subband within the plurality of subbands, uplink precoders for the scheduled uplink transmission based on the estimation; and
sending the uplink transmission using the uplink precoders.

12. The method of claim 11, wherein the irregular pattern comprises a plurality of RSs that are not uniformly distributed throughout the channel.

13. The method of claim 11, wherein the irregular pattern comprises a plurality of −RSs that are not evenly spaced throughout the channel.

14. The method of claim 11, wherein the RS configuration comprises one or more of the configured bandwidth of the RSs, an indication of the mapping of the RSs in a frequency domain, or a rotation value of the irregular pattern.

15. The method of claim 14, further comprising:
determining, by dividing the configured bandwidth of the RSs with a size of the subband on the channel for estimation, the number of subbands within the plurality of subbands on the channel for estimation.

16. The method of claim 14, wherein the indication of the mapping of the RSs in a frequency domain comprises a bitmap, wherein the bitmap indicates the location of the RSs from a set of candidate locations.

17. The method of claim 14, wherein the configured bandwidth of the RSs is wider than or equal to a bandwidth associated with the uplink transmission.

18. The method of claim 11, wherein the information associated with the irregular pattern is a sparsity order.

19. The method of claim 11, wherein the determination of the uplink precoders is based on a plurality of frequency locations within the plurality of subbands that comprise no RSs.

20. The method of claim 11, further comprising:
receiving configuration information, wherein the configuration information comprises one or more of a precoding resolution or an indication of a maximum number of multiple input multiple output (MIMO) layers.
